(19) United States
(12) Patent Application Publication
(10) Pub. No.: US 2008/0283310 A1
(43) Pub. Date: Nov. 20, 2008

(54) SYSTEM FOR USING A GROUND ELECTRODE TO AMPLIFY SIGNALS ON A CAPACITANCE SENSITIVE TOUCHPAD

(76) Inventor: J. Douglas Moore, Salt Lake City, UT (US)

Correspondence Address: MORRISS OBRYANT COMPAGNI, P.C., 734 EAST 200 SOUTH, SALT LAKE CITY, UT, 84102, US

(21) Appl. No.: 12/101,843

(22) Filed: Apr. 11, 2008

Related U.S. Application Data
(60) Provisional application No. 60/911,223, filed on Apr. 11, 2007.

(51) Int. Cl. G06F 3/044

(52) U.S. Cl. 178/18.06

(57) ABSTRACT

A capacitance sensitive touchpad having a ground electrode disposed on top of but not in electrical contact with an XY grid of electrodes, wherein a plurality of mechanical keys are disposed above but not in electrical contact with the ground electrode, wherein each of the plurality of mechanical keys includes a conductive material generally disposed on an underside that makes contact with the ground electrode when any of the plurality of keys are pressed in order to indicate actuation, wherein a signal generated by the conductive material that is in electrical contact with the ground electrode is amplified by the ground electrode and therefore detectable by the XY grid of electrodes disposed underneath the ground electrode.

### BACKGROUND OF THE INVENTION

1. Field of the Invention

This invention relates generally to capacitance sensitive touchpads. Specifically, the invention relates to an ability to amplify a signal on a touchpad surface when contact is made between a conductive material and a ground electrode or grid that is disposed over the touchpad surface, and wherein access to the electrode grid of the touchpad can be prevented to thereby make operation of the touchpad more secure by concealing operational components.

2. Description of Related Art

Point-of-sale devices are electronic appliances that read information from a credit or debit card, and then process that information so that a merchant is able to receive payment for a product or services rendered. Many point-of-sale devices include a keypad that is used for entering a PIN (personal identification number). A PIN is a password that authorizes the point-of-sale device to access a customer account associated with the credit or debit card. Whereas an account number is written on the credit or debit card, the PIN number is not so that the associated account cannot be accessed if the credit card or debit card is stolen. Therefore, it is essential that the PIN number be kept secret as it is the code that authorizes anyone to gain access to an account.

During the transaction using the point-of-sale device, a customer typically swipes a credit card or debit card through a magnetic strip reader to thereby enter the account number without having to manually type in all of the digits. After the account number is entered, the point-of-sale device is typically programmed to request that the customer manually enter the PIN number on a PIN entry device (PED) which is typically a keypad. The PED may be on the point-of-sale device itself, or attached by a cord.

Unfortunately, it is has been found through experience that point-of-sale devices are vulnerable to tampering so that the account number and the PIN number can be intercepted and stolen. The techniques used to steal the data are relatively unsophisticated, and pose a serious threat to the security of customer accounts.

Customer accounts numbers are easily obtained. It can be as simple as stealing mail. But obtaining the PIN number is the key to access an account. One method of obtaining PIN information is to intercept PIN data as it is being entered from a keypad on the PED. Keypads in point-of-sale devices can be mechanical or virtual. A virtual keypad can be implemented as a touch-sensitive surface commonly known as a touchpad. The advantage of using a touchpad for entering PIN data is that the touchpad can also be used for capturing the customer's electronic signature.

It would be an advantage over the state of the art in touchpad design to provide a touchpad that can conceal components of its sensors from anyone that tries to monitor entry of PIN data as that information is being entered into the PED. It would also be an advantage to provide a system for entering PIN data that would cease to function and thereby indicate tampering if tampering were detected.

There are several touchpad designs. One particular design that has been implemented in point-of-sale devices is a capacitance sensitive touchpad. An existing touchpad design that can be modified to work with the present invention is a touchpad made by CIRQUE® Corporation. Accordingly, it is useful to examine the underlying technology of this capacitance-sensitive touchpad to better understand how any capacitance sensitive touchpad can be modified to function as described by the present invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

With this understanding of one capacitance sensitive touchpad, it is now possible to discuss the present invention and a particular application because of shortcomings in state of the art touchpad designs and security methods.

### BRIEF SUMMARY OF THE INVENTION

In a first embodiment, the present invention is a capacitance sensitive touchpad having a ground electrode disposed on top of but not in electrical contact with an XY grid of electrodes, wherein a plurality of mechanical keys are disposed above but not in electrical contact with the ground electrode, wherein each of the plurality of mechanical keys includes a conductive material generally disposed on an underside that makes contact with the ground electrode when any of the plurality of keys are pressed in order to indicate actuation, wherein a signal generated by the conductive material that is in electrical contact with the ground electrode is amplified by the ground electrode and therefore detectable by the XY grid of electrodes disposed underneath the ground electrode.

In a first aspect of the invention, the XY grid of electrodes of the capacitance-sensitive touchpad is visually hidden from an observer.

In a second aspect of the invention, physical access to the XY electrode grid is prevented, either by constructing the XY electrode grid inside a substrate material, or an on underside of a substrate material, where the underside is then concealed and made inaccessible.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a schematic diagram of the prior art capacitance sensitive touchpad provided by CIRQUE® Corporation.

FIG. 2 is a profile view of a touchpad and a ground electrode.

FIG. 3 is a profile view of a touchpad, a housing wall and a ground electrode.

FIG. 4 is a perspective view of a substrate material on or within which the XY electrode grid of the touchpad is disposed, and a ground electrode disposed thereon.

FIG. 5 is a profile view of the components of FIGS. 2 and 4, but with a plurality of keys shown disposed above the ground electrode.

FIG. 6 is an alternative embodiment of a key that has a conductive material on an underside and a top side, such that a finger can make electrical contact with the conductive pad.

FIG. 7 is an alternative embodiment showing a profile view of a substrate and a plurality of keys disposed thereover, wherein the plurality of keys are electrically coupled and grounded, and no dedicated ground electrode is present between the keys and the touchpad.

FIG. 8 is an alternative embodiment showing a profile view of a substrate and a plurality of keys disposed thereover, wherein the plurality of keys are modified as in FIG. 6 to thereby electrically couple to a finger, and no dedicated ground electrode is present.

FIG. 9 is an alternative embodiment showing a profile view of a substrate and a plurality of keys disposed thereover, wherein the plurality of keys are modified so that a user's finger is electrically coupled to a conductive pad.

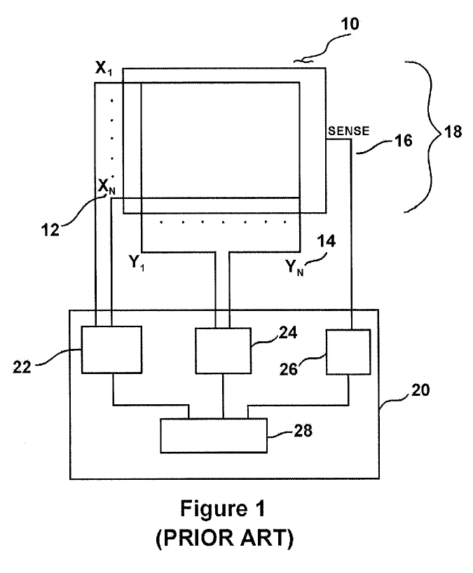

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

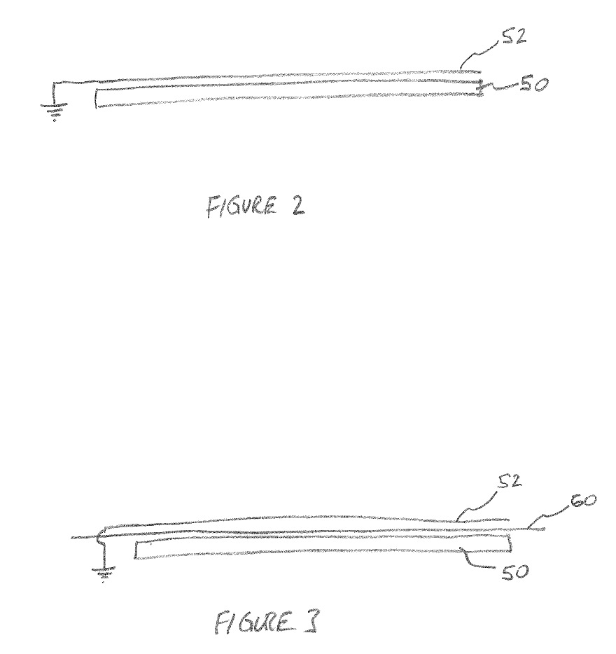

FIG. 2 is a profile of the first embodiment of the present invention. The present invention includes a capacitance-sensitive touchpad 50, such as the one manufactured by CIRQUE® Corporation. The touchpad 50 is formed from an XY electrode grid that is disposed within layers of a substrate material and is therefore not shown. On a top surface of the touchpad 50, but not in electrical contact with the XY electrode grid, is another electrode 52. This electrode is a grounded electrode, and will be referred to as a ground plane or ground electrode 52.

A substrate used in touchpads can be made from many different materials. What is important is that the substrate material be an insulator so as not to interfere with operation. Substrates are also often made with either transparent or opaque materials depending on the use of the touchpad. For example, transparent touchpads are useful when the touchpad is disposed over a display screen, such as a liquid crystal display (LCD) display. The combination results in the creation of a touchscreen. When a touchpad is not disposed over a visual display, it is often made of opaque materials, such as the materials used in printed circuit boards (PCB).

The ground electrode 52 does not have to be disposed on the same substrate as the touchpad 50. The ground electrode 52 may be disposed on its own substrate. It is important that the ground electrode 52 be physically adjacent to the entire surface of the touchpad 50 that is being used to detect the mechanical buttons being pushed to enter a PIN number.

The substrate of the touchpad 50 used in the present invention can be made from a transparent material if the ground electrode 52 uses its own substrate, as long as the ground electrode substrate is opaque. Thus, an element of the present invention is to arrange the touchpad 50 and the ground electrode 52 so that the XY electrodes of the touchpad are hidden from view. Accordingly, another embodiment of the present invention is to use a housing as a substrate material.

An important aspect of the present invention is that the touchpad itself be hidden from view. However, the ground electrode 52 must be accessible to touch, and it is therefore not hidden from view. In FIG. 2, the substrate of the touchpad 50 must be opaque if it is visible or accessible to view. Alternatively, the touchpad 50 can be hidden from view.

In FIG. 3, the touchpad 50 is hidden from view by being disposed on the underside or inside of a housing wall 60. The housing wall 60 must be a material that does not interfere with operation of the touchpad 50, and will therefore be some type of insulating material. The ground electrode 52 is then disposed directly on the housing wall 60, or on its own substrate that is then attached to the housing wall and directly over the touchpad 50.

This concealing of the XY electrode grid of the touchpad 50 serves multiple purposes. First, it is desirable that the specific physical layout of the XY electrode grid is unknown. Information about the layout of the XY electrode grid may be used to place sensors on the outside of the housing for tracking of keypad data.

Second, it is desirable that no object can be put in physical contact with the touchpad 50. Both of these aspects of the invention are designed to prevent access to operational aspects of the touchpad 50. As will be explained more fully, the present invention makes interception of data during operation of the touchpad more difficult by hiding its physical layout.

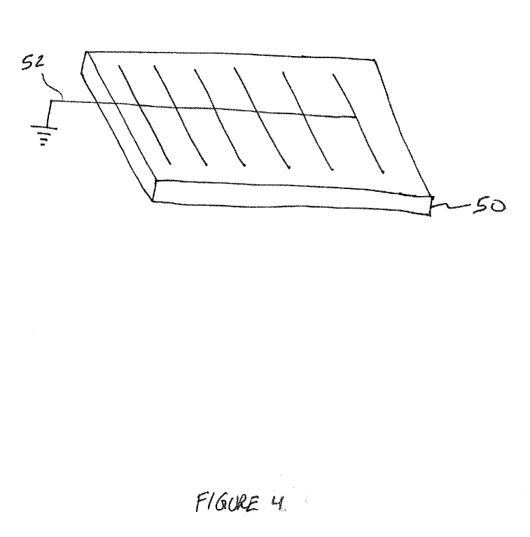

FIG. 4 is a perspective view of a touchpad 50 and the ground electrode 52 disposed on top of the substrate of the touchpad. The shape of the ground electrode 52 shown is for illustration purposes only and should not be considered as a limiting design. The ground electrode 52 is shown as having a plurality of ribs extending outward from a central spine. The ground electrode 52 can be constructed having a variety of different shapes, all of which will provide the necessary function. Thus, the shape of the ground electrode can be any desired pattern that does not interfere with the function of the ground electrode 52. The ground electrode 52 can even be a planar sheet of conductive material.

The ground electrode 52 should cover the portion of the touchpad that is used for sensing mechanical buttons being pressed. The ground electrode 52 should not be designed so that it gives a visual indication of contact points of the plurality of keys, as this would defeat the purpose of avoiding visual clues as to the locations of contact between the ground electrode 52 and the plurality of mechanical keys.

As stated previously, the specific shape of the ground electrode 52 can be modified as desired. For example, the ground electrode 52 could be in the form of a single electrode that goes back and forth from one side of the touchpad 50 to the other, such as a serpentine shape.

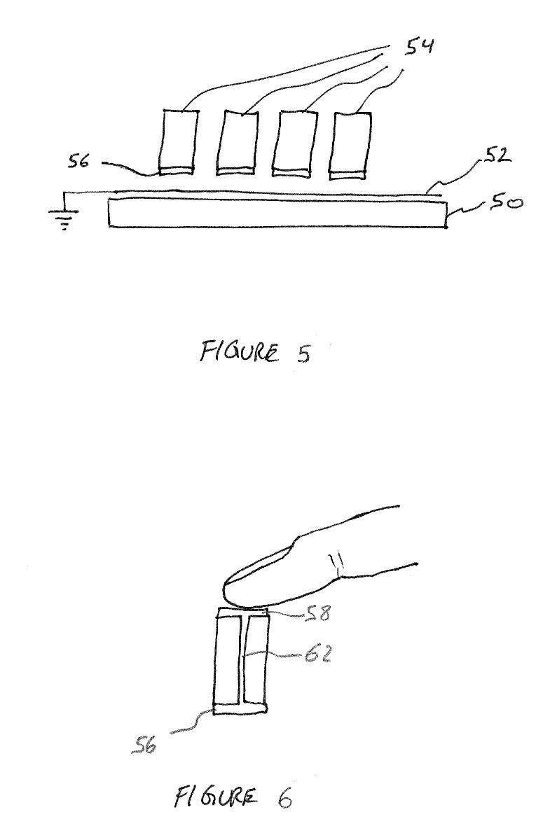

FIG. 5 is a profile view of the present invention that includes a plurality of keys 54. The plurality of keys 54 will be disposed in a housing (not shown). As shown in FIG. 3, the housing 60 may be physically separating the touchpad 50 from the ground electrode 52, or it may not. The plurality of keys 54 can make contact anywhere with the ground electrode 52.

An important aspect of the present invention is that it is not necessary to make any hardware changes in the touchpad 50 at points of contact. The programming of touchpad firmware controls operation of the touchpad 50. Any location on the touchpad 50 can be designated in firmware to correspond to data that is represented by specific keys. For example, the keys can be alphanumerical characters used to enter a PIN number.

The present invention has introduced the use of a ground electrode 52 disposed over a touchpad 50. The novel function of the ground electrode 52 is to amplify the effect of a conductive object that comes in contact with the ground electrode. The conductive object will typically be one of a plurality of keys 54 that are being actuated by pressing down on them to make contact with the ground electrode 52 in order to enter data in a sequence that represents a PIN number.

Typically, keys used in keypad entry devices are typically not conductive but are instead made from insulating materials. Accordingly, it is necessary to modify the plurality of keys 54 such that they incorporate conductive materials.

In a first embodiment of the plurality of keys 54 shown in FIG. 5, a conductive pad 56 is disposed on a bottom surface of each key. The conductive pad 56 can be made from any conductive material, such as a metallic disk or carbon ink pills. What is important is that the shape of the conductive pad 56 be large enough to make contact with the ground electrode 52. Experimentally, the conductive pad 56 is more visible to the touchpad 50 when the grounding electrode 52 is present than if the conductive pad made contact directly with the substrate of the touchpad. It is believed that the algorithms of a typical CIRQUE® Corporation touchpad will not require any modification to detect the conductive pad 56 as it makes contact with the ground electrode 52.

FIG. 6 is provided to illustrate an alternative embodiment of the invention. Specifically, each key of the plurality of keys 54 can be made such that the conductive material of the conductive pad 56 extends upwards through each of the keys via bridge 62 to another conductive pad 58 on top. The purpose of extending the conductive material to the top of each of the plurality of keys 54 is to couple the conductive material to a large grounded object, which is typically the user. Typically, a user will make contact with one of the plurality of keys 54 with a finger. The finger thus acts as another ground source which can have the effect of making the conductive pad 56 even more visible to the touchpad 50.

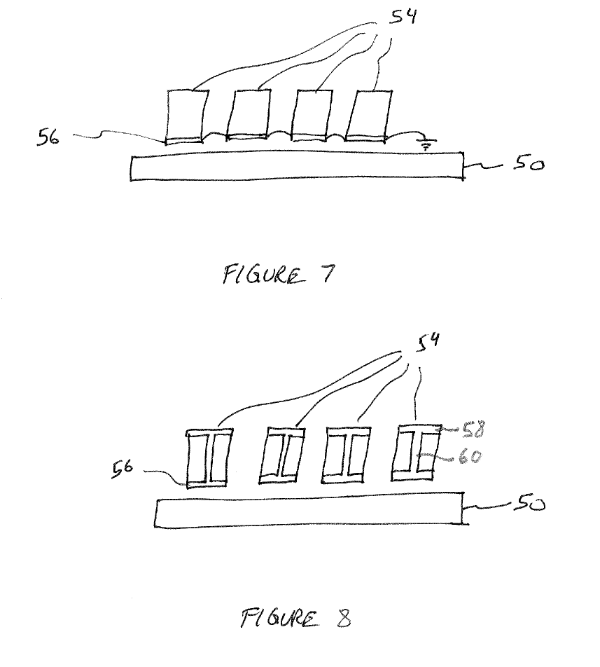

FIG. 7 is provided to illustrate another alternative embodiment of the present invention. Instead of providing a ground electrode 52, the conductive pads 56 on the plurality of keys 54 are electrically coupled to each other and to an electrical ground. Again, the present invention uses an electrical connection to ground to amplify the effect of a key of the plurality of keys 54 making contact with or coming in close proximity to the touchpad 50.

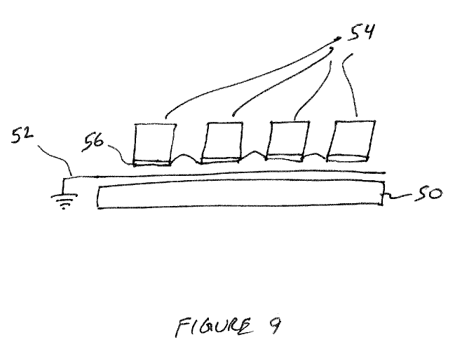

In another alternative embodiment shown in FIG. 8, the plurality of keys 54 are all manufactured as shown in FIG. 6, wherein a conductive material on each of the keys passes via bridge 62 to a conductive pad 58 on a top side and a conductive pad 56 on a bottom side, thereby coupling a user's finger to the conductive material 56. No ground electrode is being used between the plurality of keys 54 and the touchpad 50. Instead, the fact that the user functions as a ground has the effect of amplifying the effect of the conductive pad 56 on the touchpad 50.

FIG. 9 is provided as another alternative embodiment of the present invention. The plurality of keys 54 are electrically coupled to each other as in FIG. 7. The conductive pads 56 are not electrically grounded, but are all coupled to each other. However, the ground electrode 52 is now provided.

All of the embodiments of the present invention are designed to amplify the effect that a grounded object will have on a touchpad 50. Essentially, by creating a stronger ground for the object that makes contact with or comes in close proximity to the touchpad 50, the touchpad is able to more easily see the object. Accordingly, other configurations of keys, ground electrodes and electrical connections between them should be considered to be within the scope of the present invention.

One application of the present invention has been suggested as improving security of a PED by hiding the touchpad from view. The hidden touchpad 50 operates effectively by using the present invention to amplify the effect that each key has on the touchpad.

One possible method of “hacking” a PED to steal confidential information is to insert some sort of material under the keys to enable detection of the keys being pressed. Such a material might therefore be inserted on top of the ground electrode 52. The effect of the insertion of the material might be to make operation of the touchpad 50 impossible. Thus, not only would operation of the present invention be prevented, but this inability to function would itself be an indication that the PED had been tampered with.

The present invention also makes it impossible to determine, just by examining the touchpad 50, where contact is going to be made between each of the plurality of keys 54 and the ground electrode 52 because no specific location on the touchpad has to be designated in hardware. Advantageously, the expected touchdown location of each of the plurality of keys is programmable in touchpad firmware, and does not need to be determined at the time of manufacturing. The firmware can be changed as desired so that not only can different alphanumerical characters be generated, but the locations of contact by keys with the ground electrode 54 can also be changed as desired. This gives the manufacturer of the PED greater flexibility in design of keys and where they make contact with the touchpad 50. Furthermore, the actual XY electrode grid of the touchpad 50 is inaccessible to a user, making it secure from tampering.

In an alternative embodiment for PED tampering prevention, the present invention makes it possible to install a different keypad each day for use with the PED. Each keypad would use keys that are arranged differently from other keypads. The user would only have to enter some identifying information associated with a particular keypad. The touchpad firmware would then be looking for contact by keys at locations that are different from other keypads.

It should be understood that when a user's finger is isolated from a conductive pad in a key, that the user will have no effect on the touchpad. Therefore, the conductive object making contact with the ground electrode would simply be the conductive pad on the key itself.

It should also be understood that it may not be necessary for a conductive object to make direct contact with the ground electrode for the effect of the conductive object on the touchpad to be felt. As the touchpad can be a proximity sensitive device, the approach of the conductive object near to the ground electrode may be sufficient for the enhancement effect of the ground electrode to occur.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for increasing the effect of a conductive object on a capacitance-sensitive touchpad, said method comprising the steps of:
1) providing a capacitance-sensitive touchpad;
2) providing a ground electrode that is electrically isolated from the touchpad but is also disposed so as to suspended adjacent to and directly over a sensor area of the touchpad;
3) making contact between a conductive object and the ground electrode; and
4) detecting a presence of the conductive object by the touchpad, and wherein an effect of the conductive object on the touchpad is enhanced sensing of the conductive object by contact between the conductive object and the ground electrode.

2. The method as defined in claim 1 wherein the method further comprises the steps of:
1) concealing the touchpad from view; and
2) making the ground electrode accessible to touch.

3. The method as defined in claim 2 wherein the method further comprises the steps of:
1) disposing the touchpad within a housing; and
2) disposing the ground electrode on a surface of the housing and directly over a location of the touchpad.

4. The method as defined in claim 1 wherein the method further comprises the step of disposing the ground electrode on a substrate of the touchpad.

5. The method as defined in claim 1 wherein the method further comprises the step of disposing the ground electrode on a substrate that is separate from the touchpad.

6. The method as defined in claim 1 wherein the method further comprises the steps of:
1) providing a plurality of keys disposed over the ground electrode, wherein each of the plurality of keys will make contact with ground electrode when pressed; and
2) providing a first conductive pad on a bottom side of each of the plurality of keys.

7. The method as defined in claim 6 wherein the method further comprises the step of providing a means for electrically connecting a large grounded object to the first conductive object to thereby enhance the effect of the first conductive pad on the touchpad.

8. The method as defined in claim 7 wherein the method further comprises the steps of:
1) providing a second conductive pad on a top surface of each of the plurality of keys; and
2) providing a conductive bridge between the first conductive pad and the second conductive pad, wherein a finger making contact with the second conductive pad will connect the first conductive pad to the large conductive object.

9. The method as defined in claim 6 wherein the method further comprises the steps of:
1) removing the ground electrode;
2) providing an electrical connection between each of the first conductive pads; and
3) providing an electrical connection between the first conductive pads and ground to thereby increase a size of a ground electrode.

10. The method as defined in claim 1 wherein the method further comprises the steps of:
1) removing the ground electrode;
2) providing a plurality of keys disposed over the ground electrode, wherein each of the plurality of keys will make contact with ground electrode when pressed;
3) providing a first conductive pad on a bottom side of each of the plurality of keys;
4) providing a second conductive pad on a top surface of each of the plurality of keys; and
5) providing a conductive bridge between the first conductive pad and the second conductive pad, wherein a finger making contact with the second conductive pad will connect the first conductive pad to a large conductive object.

11. A system for increasing the effect of a conductive object on a capacitance-sensitive touchpad, said system comprised of:
a capacitance-sensitive touchpad; and
a ground electrode that is electrically isolated from the touchpad but is also disposed so as to be suspended adjacent to and directly over a sensor area of the touchpad, wherein an effect of a conductive object on the touchpad is increased when the conductive object is brought in contact with the ground electrode.

12. The system as defined in claim 11 wherein the system is further comprised of a housing, wherein the touchpad is disposed within the housing and the ground electrode is disposed on a surface of the housing and directly over a location of the touchpad.

13. The system as defined in claim 11 wherein the system is further comprised of disposing the ground electrode on a substrate of the touchpad.

14. The system as defined in claim 11 wherein the system is further comprised of disposing the ground electrode on a substrate that is separate from the touchpad.

15. The system as defined in claim 11 wherein the system is further comprised of:
a plurality of keys disposed over the ground electrode, wherein each of the plurality of keys will make contact with ground electrode when pressed; and
a first conductive pad on a bottom side of each of the plurality of keys.

16. The system as defined in claim 15 wherein the system is further comprised of a means for electrically connecting a large grounded object to the first conductive object to thereby enhance the effect of the first conductive pad on the touchpad.

17. The system as defined in claim 16 wherein the system is further comprised of
a second conductive pad disposed on a top surface of each of the plurality of keys; and
a conductive bridge disposed between the first conductive pad and the second conductive pad, wherein a finger making contact with the second conductive pad will connect the first conductive pad to the large conductive object.

18. A system for increasing the effect of a conductive object on a capacitance-sensitive touchpad, said system comprised of:
a capacitance-sensitive touchpad;
a plurality of keys disposed over the ground electrode, wherein each of the plurality of keys will make contact with ground electrode when pressed;
a first conductive pad on a bottom side of each of the plurality of keys;
a second conductive pad disposed on a top surface of each of the plurality of keys; and
a conductive bridge disposed between the first conductive pad and the second conductive pad, wherein a finger making contact with the second conductive pad will connect the first conductive pad to the large conductive object.

19. A system for increasing the effect of a conductive object on a capacitance-sensitive touchpad, said system comprised of:
a capacitance-sensitive touchpad;
a plurality of keys disposed over the ground electrode, wherein each of the plurality of keys will make contact with ground electrode when pressed;
a first conductive pad on a bottom side of each of the plurality of keys;
an electrical connection disposed between each of the first conductive pads; and
an electrical connection between the first conductive pads and ground to thereby increase a size of a ground electrode.

20. A system for increasing the effect of a conductive object on a capacitance-sensitive touchpad, said system comprised of:
a plurality of keys disposed over the ground electrode, wherein each of the plurality of keys will make contact with ground electrode when pressed;
a first conductive pad on a bottom side of each of the plurality of keys;
a second conductive pad disposed on a top surface of each of the plurality of keys; and
a conductive bridge disposed between the first conductive pad and the second conductive pad, wherein a finger making contact with the second conductive pad will connect the first conductive pad to the large conductive object.
